(19) United States
(12) Patent Application Publication
(10) Pub. No.: US 2003/0048172 A1
(43) Pub. Date: Mar. 13, 2003

(54) Composition and method for manufacturing integral resistors in printed circuit boards

(75) Inventors: Jonathan H. Meigs, Bennington, VT (US); Derek Carbin, Bennigton, VT (US)

Correspondence Address: Roberts & Mercanti, LLP, P.O. Box 484, Princeton, NJ, 08542-0484, US

(73) Assignee: Oak-Mitsui

(21) Appl. No.: 10/267,726

(22) Filed: Oct. 8, 2002

Related U.S. Application Data
(62) Division of application No. 09/361,458, filed on Jul. 27, 1999.
(60) Provisional application No. 60/094,746, filed on Jul. 31, 1998.

(51) Int. Cl. H01C 1/012

(52) U.S. Cl. 338/308

(57) ABSTRACT

An electrically resistive foil comprising a resistive composite material including a conductive material and a non-conductive material alone or incorporated into a two layer foil material that includes a conductive metal layer and a layer of the resistive composite material. This invention also includes circuit boards comprising an insulative substrate and an integral resistor comprising the resistive composite material of this invention as well as methods for manufacturing printed circuit boards including integral resistors.

### BACKGROUND OF THE INVENTION

This application claims priority to Provisional Application Serial No. 60/094,746 filed on Jul., 31, 1998.

### FIELD OF THE INVENTION

This invention relates to a resistive composite material including the combination of a conductive material and a non-conductive material. This invention also relates to multi-layer foils including a conductive foil layer and a resistive composite material layer that is deposited on conductive foil layer. Furthermore, this invention relates to a circuit board comprising an insulative substrate and an integral resistor comprising a resistive composite material including a conductive material and a non-conductive material wherein the resistive composite material is laminated to the insulative substrate.

### DESCRIPTION OF THE ART

In order to reduce the size, cost and to improve the reliability of electronic products, there has been an increasing need to replace discrete electronic components with integral components which are produced as part of the printed circuit board manufacturing process. At present, integral resistance is produced using a copper foil that has been plated with a material with a resistance that is greater than the resistance of copper foil.

A problem with prior art resistive layers is that they are very thin due to their material of manufacture. Because the resistive layers are thin, they are prone to damage by handling throughout the manufacturing process, from scratches, cracking due to flexures, and other physical hazards. For example, a resistive layer formed of pure nickel would have to be approximately 0.00174 microns thick to achieve a 50 ohm per square sheet resistivity. Such a thin resistive film layer is easily damaged.

The use of nickel phosphorous alloys to create higher sheet resistance is described in U.S. Pat. No. 3,808,576, the specification of which is incorporated herein by reference. In practice, nickel phosphor materials, while providing thicker resistive layers for a given sheet resistance than pure nickel, still produce what are considered thin resistive layers that experience damage and resulting production losses when they are used in the manufacture of circuit boards. Nickel phosphor resistive layers are also only commercially available in a limited range of sheet resistance, up to 1000 ohms per square.

The present technology is limited in several ways. The specific resistivity of the material is insufficient to eliminate large value resistors, thus limiting application of the present technology. Also, the alloying process by which the material is produced yields poor resistive circuit uniformity across a printed circuit panel, thus reducing yields and increasing re-work. This is due in part to the perceived necessity of plating the resistive layer to the matte surface of the electrodeposition foil for adhesion.

As a result, there remains a need for integral resistor foils with improved electrical and thermal dissipative properties in higher resistive applications.

### SUMMARY OF THE INVENTION

It is an object of this invention to provide resistive composite material that, when incorporated into a layered foil, can be easily associated with a circuit board substrate and processed to create discrete integrated passive resistors.

It is yet another object of this invention to provide foils that are useful in the manufacture of printed circuit boards with integral resistors.

Yet another object of this invention are metal foil compositions and methods for using the metal foil compositions to produce a printed circuit board including integral resistors wherein the integral resistors are resistant to variation and degradation due to flexing and cracking of the resistor material.

In still another object, this invention includes foil compositions and methods for using the foil compositions to manufacture printed circuit board including integral resistors at high yields and improved uniformity.

This invention includes an electrically resistive composite material comprising a conductive material and a non-conductive material.

This invention also includes a multi-layer foil comprising a conductive metal layer and a layer of resistive composite material.

In a further aspect, this invention includes a multi-layer foil comprising a copper metal layer having a shiny surface and a matte surface and an electrically resistive co-deposit composite material layer associated with a copper metal layer surface wherein the electrically resistive co-deposited composite material layer includes from about 0.01 to about 99.9 area % of a conductive metal other than copper and from about 0.01 to about 99.9 area % of particles of a non-conductive material selected from alumina, boron nitride, and mixtures thereof.

Yet another aspect of this invention is an integral resistor comprising (a) an insulative substrate layer having first surface and a second surface; (b) an integral resistor located on the insulative substrate first surface wherein the integral resistor further comprises a co-deposit material including a conductive material and a non-conductive material and wherein the integral resistor has a first end and a second end; and (c) a first conductive metal layer associated with the integral resistor first end and a second conductive metal associated with the integral resistor second end.

### DESCRIPTION OF THE FIGURES

FIGS. 1-8 depict steps of a method for using foils made from resistive composite materials of this invention to manufacture laminates that include integral resistors that are useful in the manufacture of printed circuit boards.

FIG. 9 is a cross section view of an integral resistor including a co-deposited resistive composite material layer 12 including a conductive metal along with a plurality of non-conductive particles 36.

### DESCRIPTION OF THE CURRENT EMBODIMENT

The present invention relates to a resistive composite material comprising at least one conductive material and at least one non-conductive material. This invention also relates to an improved layered foil comprising a conductive metal layer having a shiny side and a matte side and resistive composite material layer associated with the conductive metal layer. The present invention also relates to laminates, printed circuit boards, and other electronic substrates that include at least one integral resistor manufactured using the composite material of this invention.

An improved electrically resistive composite material has been developed that is useful in manufacturing printed circuit boards and other electronic substrates that include integral resistors. The composite material includes a conductive material and a non-conductive material. The composite materials are useful when formed into electrically resistive foils in manufacture of printed circuit boards that contain one or more integral reisitors.

Foils including electrically resistive composite materials of this invention can be manufactured by well known electrodeposition processes using an electroplating solution including solid non-conductive particles and at least one conductive metal ion that forms a conductive metal upon electroplating. The conductive metal used in the resistive material and/or in the conductive metal layer of the layer foil material of this invention may be any metal, metalloid, alloy, or combination thereof that is able to conduct an electrical current. Examples of conductive metals that are useful as the conductive metal or alloy in the resistive co-deposit material of this invention include one or more of the following: antimony (Sb), arsenic (As), bismuth (Bi), cobalt (Ce), tungsten (W), manganese (Mn), lead (Pb), chromium (Cr), zinc (Zn), palladium (Pd), phosphorus (P), sulfur (S), carbon (C), tantalum (Ta), aluminum (Al), iron (Fe) titanium (Ti), chromium, platinum (Pt), tin (Sn), nickel (Ni), silver (Au), and copper (Cu). The conductive metals and alloys may also be chosen from alloys of one or more of the above-identified conductive materials or a plurality of layers of one or more of the above-identified conductive metals or alloys.

Non-conductive materials in the resistive composite materials of this invention may be any non-conductive material that can be combined with a conductive metal to give a useful co-deposited electroplated resistive foil layer. It is preferred that the non-conductive material is a particulate material that can be evenly dispersed throughout the resistive foil material. Such particulate materials include but are not limited to metal oxides, metal nitrides, ceramics, and other particulate non-conductive materials. It is more preferred that the particulate non-conductive materials are selected from boron nitride, silicon carbide, alumina, silica, platinum oxide, tantalum nitride, talc, polyethylene tetra-fluoroethylene (PTFE), epoxy powders, and mixtures thereof.

It is most preferred that the resistive co-deposit layer be co-deposited from an electrolyte solution having a pH of from 2 to 6, a temperature of from 25 to 45° C. and including from about 20 to about 250 g/l of nickel sulfamate and from about 10 g/l to about 300 g/l or more alumina or boron nitride particles. The alumina and boron nitride particles will preferably have a mean particle size ranging from about 0.01 to about 20 microns and most preferably a mean particle size less than about 1.0 microns. The resulting co-deposited composite material layer may be tailored to have a resistivity of from about 1 to about 10,000 ohms/square. This will generally correspond to an amount of non-conductive material in the co-deposit layer ranging from about 0.01 to about 99.9 area %.

The effective cross sectional area of the electrically resistive composite material layer is an important factor in determining the thickness and the resistance of the integral resistors manufactured using the materials of this invention. The term effective cross-sectional area refers to the cross-sectional area of the conductive metal portion of the resistive material. The resistive materials of this invention, therefore, may have an effective cross-sectional area of from about 0.01% to about 99.9% conductive area. This corresponds to a metal thickness of from about 1 Angstrom to about 3 microns.

The use of an electrically resistive composite material to manufacture integral circuit board components has several benefits. The co-deposit material can be manufactured into a resistive layer that is thick enough to withstand incidental damage during processes for manufacturing and using the material. In addition, by varying the composite material ingredient ratios, the composite material can be formed into resistive foils that have a uniform thickness but with varying sheet resistivities. This allows for more uniformity in the manufacture of circuit board components including resistive composite material foils of this invention.

The advantages of using composite materials of this invention to form resistive sheets can be understood from the following hypothetical example. If a 50 ohm per, square sheet resisitivity is desired, it can be manufactured by creating a co-deposit of a conductive material (such as nickel) and particles of a non-conductive material having, for example, a mean particle size of about 0.3 microns. A resistive material layer thickness of 1 micron will, therefore, correspond to a resistive layer approximately 3 particles thick. If these particles are plated to a thickness of 0.0002 microns of pure nickel around each particle and close packed, it will result in a sheet having a resistance of approximately 50 ohms with a sheet thickness of 1 micron. In contrast, a resistive layer produced with only pure nickel would have a thickness of 0.00174 microns. Thus, a resistive film of composite material is over 500 times as thick as an equally resistive film of pure nickel. As a result, the resistive layer of co-deposit material is less prone to resistive variations due to physical damage.

This invention also includes multi-layer resistive foils. The multi-layer resistive foils of this invention include a conductive metal layer and a resistive composite material layer to give a composite foil having at least two layers. The multi-layer foils are useful for manufacturing printed circuit boards that include integral resistors which are useful for impedance adjustment, current limiting, voltage dividing, time constants, filter networks, and so forth.

The multi-layer foil conductive metal layer will consist essentially of at least one conductive metal or alloy. The conductive metal used in the conductive metal layer may be selected from the same conductive metals and alloys that are useful in the manufacture of the resistive materials of this invention except that the conductive metal layer is preferably not the same metal that is selected as in the composite material conductive material. Choosing dissimilar conductive metals allows more flexibility in the circuit board manufacturing process including, for example, the ability to selectively etch the conductive metal from the two layer foil without disturbing the co-deposited material layer after the two layer foil is laminated to an insulative substrate.

A preferred conductive metal layer is a surface treated copper foil described in U.S. Pat. No. 5,679,203, the specification of which is incorporated herein by reference. A preferred two layer foil is prepared by co-depositing, by electrodepositing, an electrically resistive composite material comprising a conductive material, such as nickel and a particulate non-conductive material such as alumina or boron nitride on the surface treated smooth side or on the matte side of the preferred copper film. It is preferred that the resistive composite material be of high thermal conductivity to improve thermal dissipation characteristics of an integral resistor made with the composite material. The resistive composite material layer that is applied to a surface of the conductive metal layer may be applied to the smooth surface or to the matte surface of the conductive foil. It is preferred however to apply the resistive composite material layer to the smoother surface of the conductive foil. Electrodeposition on the smooth side forms a composite material layer that exhibits more uniform cathodic polarization of the surface than composite material layers on the matte side of an electrodeposited copper film, thereby improving microuniformity of the composite material layer. Furthermore, the time required to etch the undesired resistive areas from the laminate is reduced due to the lower profile of the smooth surface. This reduced etching time also contributes to improved uniformity and density of integrated resistors manufactured from the products of this invention.

An adhesion promoting treatment may be applied to the conductive foil smooth surface to promote adhesion of the resistive layer to the conductive foil surface. This adhesion promoting layer may be the resistive composite material layer itself. Adhesion may also be promoted by applying chemically bonded substances, for example silane coupling agents, by application of surface-active substances to improve contact with and flow into the mechanical adhesion promoting treatment during lamination, and by other techniques well known to those of skill in the art of producing metal foils for electric applications.

It is preferred that if a two layer foil is used that the conductive metal is copper. The thickness of the conductive metal layer will depend upon its final use. The thickness of the resistive co-deposit material layer will depend upon the desired integral resistor resistance which will range from about 0.1 to about 12,000 ohms/square in final use.

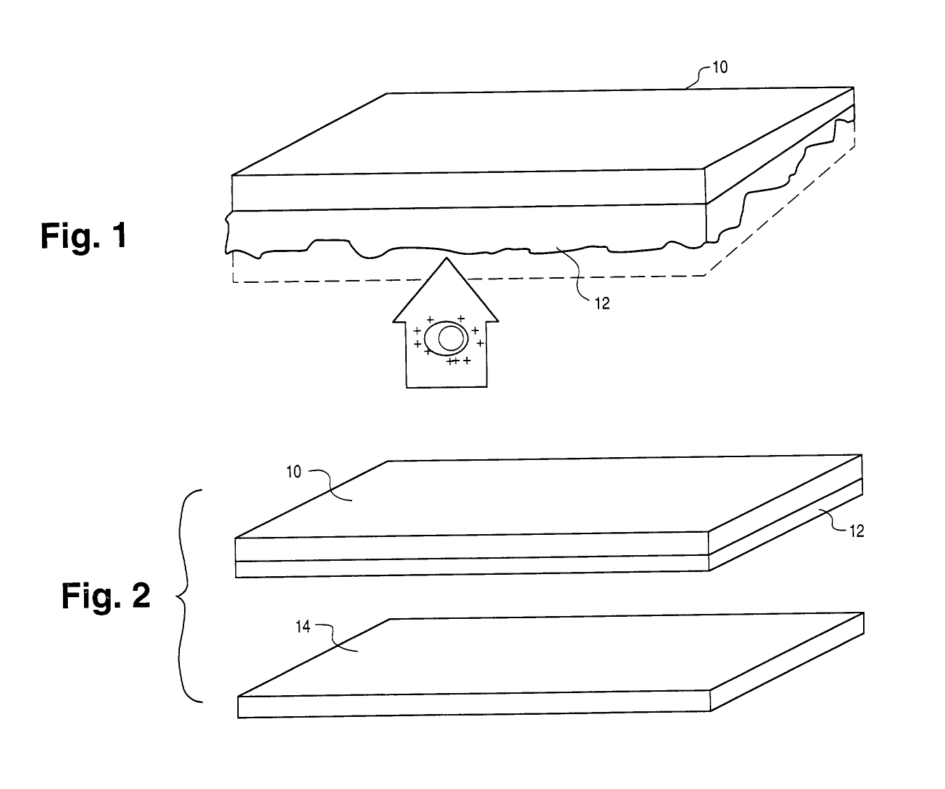

FIGS. 1-8, relate to a method for using a two layer foil including a resistive co-deposit material layer to manufacture a printed circuit boards including at least one integral resistor. As is shown in FIGS. 1-2, a two layer foil including a composite material layer 12 and a conductive metal layer 10 is laminated to an insulative substrate material 14 such that the composite material layer 12 is sandwiched between the insulative substrate material 14 and the conductive metal layer 10. The insulative substrate material 14 may be made of any materials known in the art for manufacturing printed circuit boards including, but not limited to, the reaction product of formaldehyde and urea or formaldehyde and melamine, epoxy type resins, polyester resin, phenolic resins made by the reaction of phenol and formaldehyde, silicones, polyamides, di-allyl phthalates, phenysilane resins, and ceramics such alumina, beryllium oxide, silicon nitride, mixtures thereof and so forth.

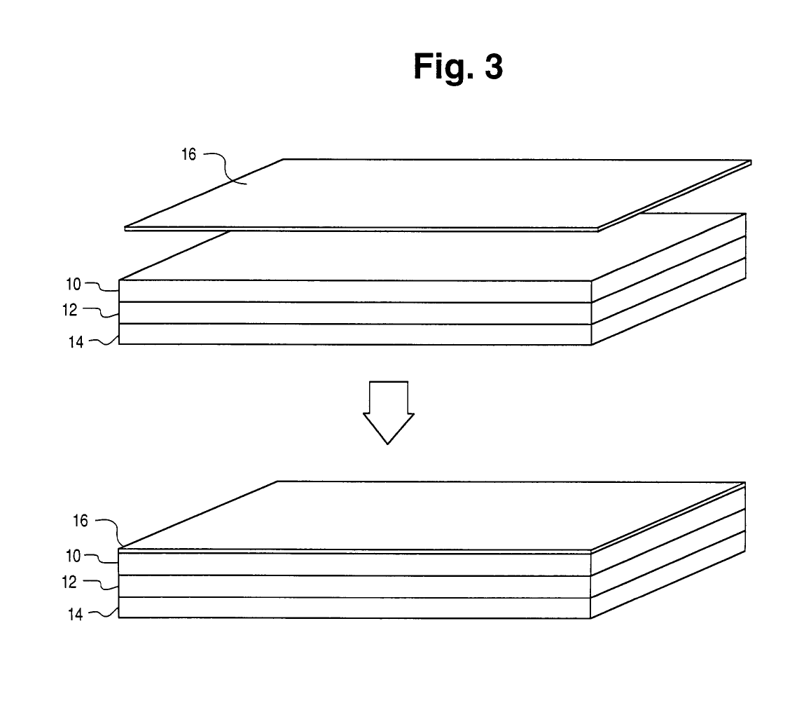

As is shown in FIG. 3, a photosensitive etch resist material 16 is applied to the exposed surface of the conductive metal layer 10.

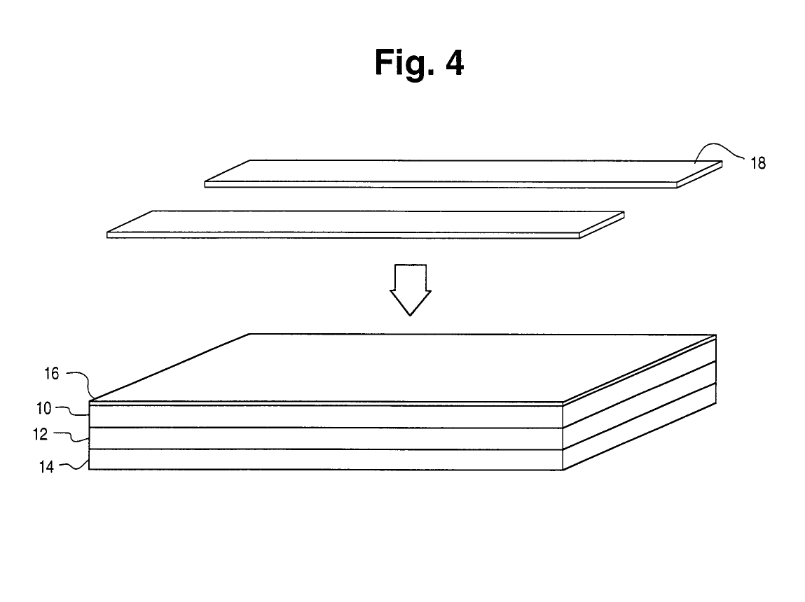

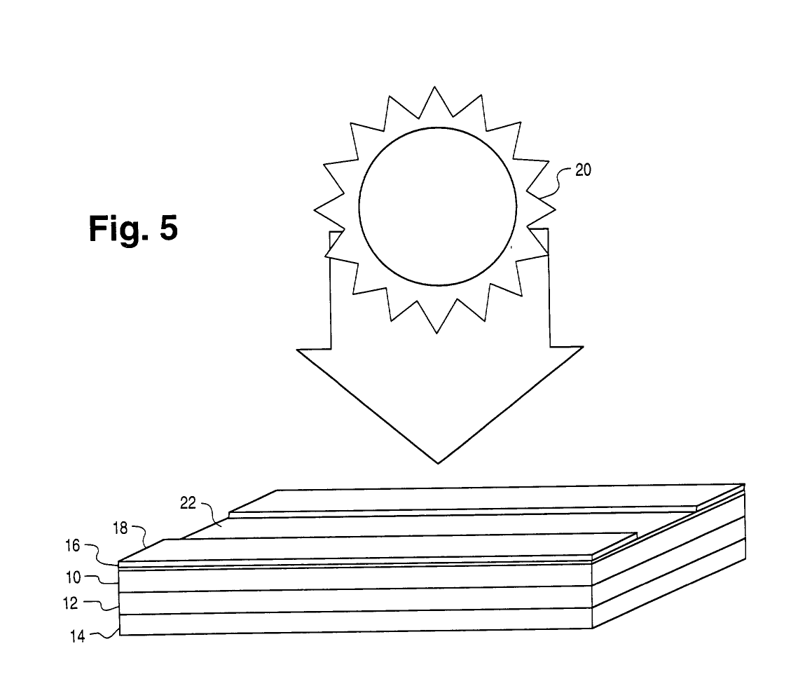

As is shown in FIGS. 4-5, a photo tool 18 embodying the desired pattern is placed over the photosensitive etch resist layer 16 and the combination is exposed to or irradiated with a suitable light source 20 to produce a photo image negative which is then chemically developed. During the chemical development, the non-irradiated portions of the photoresist are soluble in developer and thus removed and the irradiated exposed portions 22 of photosensitive etch resist material 16 which are insoluble in the developer remain fixed to conductive metal layer 10.

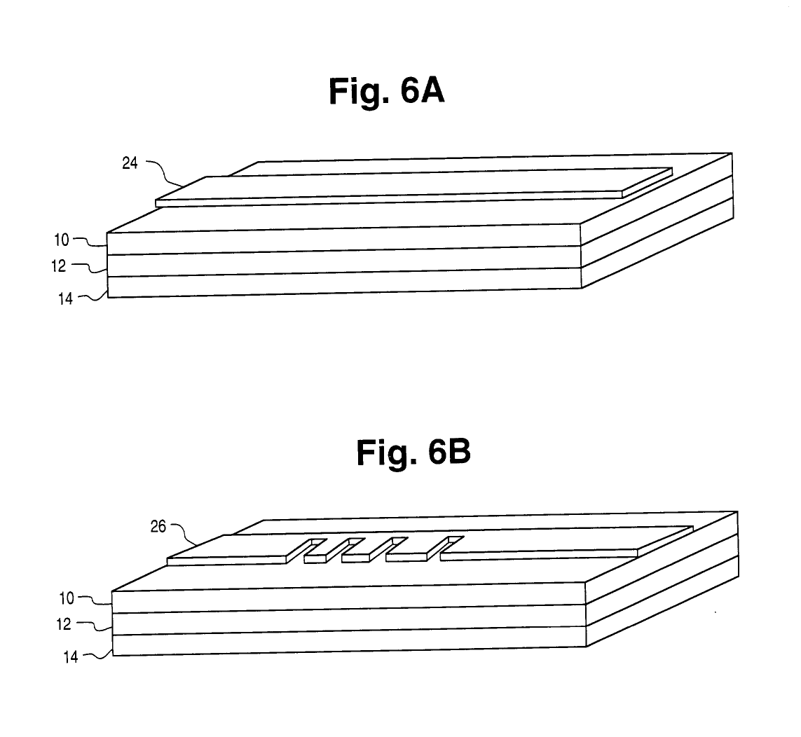

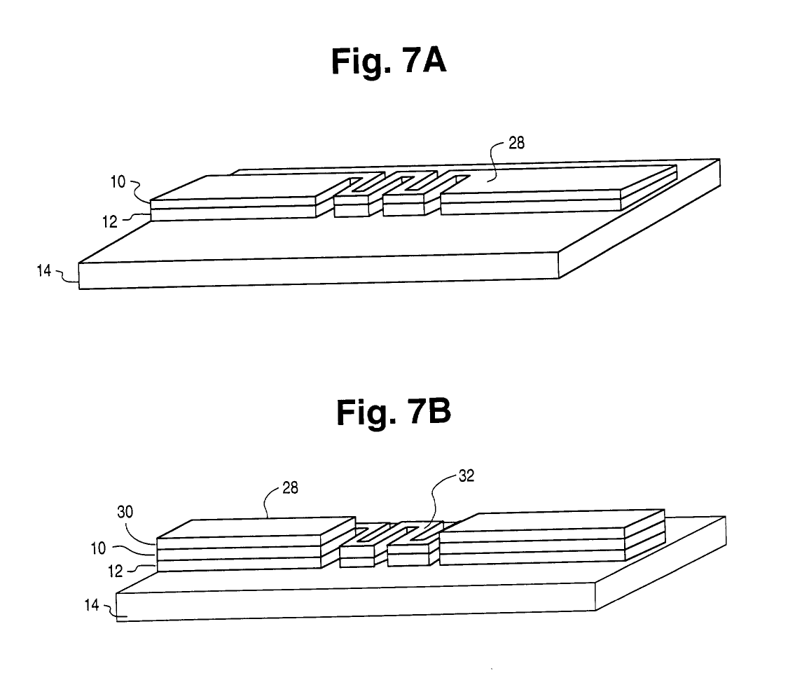

FIG. 6A depicts an intermediate product including an insulative substrate layer 14, a composite material layer 12, a conductive material layer 10, and a photosensitive etch resist material layer wherein the photosensitive etch resist material layer has been developed to leave an intermediate etch resist pattern 24. In FIG. 6B, intermediate resist pattern is imaged and developed to create serpentine traces 26 in the shape of a patterned resistor in the remaining developed etch resist material 24. Next, the layer of conductive metal and resistive metal that are not protected by the developed photoresist material are removed utilizing a suitable acid etching solution such as cupric chloride, ferric chloride, and cupric and sulfuric acids. The etching step yields a partially completed integral resistor, as shown in FIG. 7A, which includes insulative substrate layer 14, composite material layer 12, and conductive, metal layer 10 wherein portions of both composite material layer 12 and conductive metal layer 10 have been removed by chemical etching to give a partially formed integral resistor 28.

FIG. 7B shows the intermediate laminate of FIG. 7A with a second etch resist material layer 30 applied to the exposed surface of the unetched conductive metal layer and developed to expose a portion 32 of the conductive metal layer that corresponds to the location of the integral resistor. The intermediate product shown in FIG. 7B is formed by selectively applying etch resist material layer 30 to the exposed conductive metal surface 10. A photographic tool is then placed over applied etch resist material layer 30 and then exposed or irradiated. The irradiated etch resist material is then developed to give a pattern resist 32 wherein the developed pattern resist leaves the conductive metal portion of the partially completed integral circuit associated with the integral resistor unprotected.

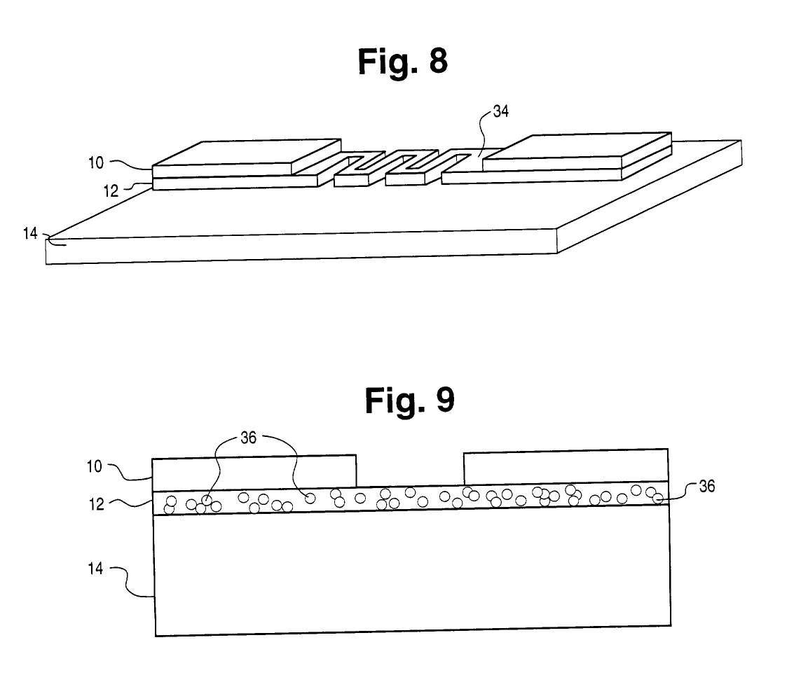

The unprotected areas of conductive metal layer 10 are etched away with an ammoniacal or alkaline etchant to expose an integral resistor 34 that comprises a patterned co-deposited resistive material with a conductive metal layer associated with each end of the integral resistor 34 as shown in FIG. 8. The conductive metal layer portion covering integral resistor 34 is etched from the integral resistor using any suitable etching solution which, in the preferred embodiment where copper is the conductive metal, is selected from ammonium persulfate, ammonical chlorides and other commercial ammonical etchants.

FIG. 8 depicts a completed circuit board integral resistor including an insulative substrate layer 14 on which is located a composite material layer 12 in the form of an integral resistor and on which is located a conductive metal layer 10 wherein the conductive metal layer has been etched from the resistive layer corresponding to integral resistor 34.

FIG. 9 is a cross section view of an integral resistor including an insulative substrate layer 14, a resistive co-deposit layer 12 that includes a conductive material and plurality of non-conductive particles 36, and a conductive metal layer 10.

Alternatively, circuit board including integral resistors of this invention may be manufactured by: (1) preparing a laminate comprising an insulative substrate layer and a resistive composite material layer; (2) applying, developing and removing undeveloped photoresist material from the resistive co-deposit layer to form circuit traces such that the developed photoresist material is in the form of the desired integral resists; (3) etching the unprotected resistive composite material layer from the insulative substrate; (4) removing the photo resist material from the remaining composite material layer; (5) applying and developing a photoresist material over the integral resistor portions of the resistive composite material layer; and (6) applying a conductive metal to the unprotective portions of the resistive composite material layer by, for example, electrodeposition.

### EXAMPLE

This Example describes the manufacture of a composite foil of this invention as well as a method for using the two layer foil to manufacture a printed circuit board including integral resistors.

Materials

The manufacture of copper foil by electrolytic deposition is well known in the art and does not require detailed description here. Copper foils are conventionally produced by electrodepositing copper from solution onto a rotating metal drum.

Treatment

A treated copper foil prepared according to the method disclosed in U.S. Pat. No. 5,679,230 was used in this Example. To summarize the '230 patent, the side of the foil next to the drum is smooth (“shiny”) side while the other side has a relatively rough surface (“the matte side”). The shiny side of copper foil may be treated to deposit copper grains on the surface to roughen it, and thus facilitate subsequent laminate adhesion. A first layer of copper particles to improve bonding is subsequently encapsulated according to this invention with the resistive layers of codeposited solids and metal. Alternatively, the copper particles may be encapsulated with another layer of copper prior to the co-deposition step. Furthermore, the copper adhesion treatment may be omitted, and the resistive layer created directly on the shiny side of the foil, in cases where such a layer would provide sufficient adhesion in lamination.

The non-conductive particulate to be co-deposited on, the metal foil surface should have a diameter less than about 20 microns, be dispersible in the co-deposition bath, and be resistant to reaction with all subsequent chemistries, for example etchant solutions. Preferred are particles with high dielectric strength, high thermal conductivity, ease of drillability or machinability, for example boron nitride. Aluminum oxide (alumina) is another preferred non-conductive material, due to cost, stability, porosity and availability. Either material will successfully produce a resistive layer.

The codeposit layer is produced using an electroplating bath containing the suspended, dispersed particles of non-conductive material and an appropriate solution for depositing the conductive metal or metal alloy. In this case, the copper foil is treated with a co-deposit layer from a bath containing 90 grams per liter Ni sulfamate and 30 grams per liter of alumina having a mean particle diameter of about 0.3 microns.

The final sheet resistivity of the co-deposit layer is a function of the volume percentage of non-conductive particles included, and overall thickness of the metal deposit. The area percent of non-conductive particles in the co-deposit layer may range from about 0.1 to about 99.9 wt %. Other electrical properties, such as power dissipation are functions of these parameters as well. Thus, a broad range of combinations of thickness and codeposit ratio produce a wide desired range of resistive products. At one extreme, a layer of metal or metal alloy containing virtually no detectable particles in the deposit will generally produce a low sheet resistivity. At the other extreme, a deposit composed of particles with just sufficient metal/metal alloy to provide required mechanical and electrical properties generally provide the highest sheet resistivities. These properties can be controlled by adjusting plating current density, plating time, flow, % non-conductive solids contained in the electrolytic bath, bath temperature, pH and other plating variables as is well known in the art.

In this example, a co-deposited resistor material was formed on a copper foil carrier by the following method. A nickel plating solution was prepared with a concentration of 90 grams nickel sulfamate per liter of deionized water. To this was added 30 grams per liter of alumina powder having a mean particle size 0.3 micron. The mixture was heated, with agitation, to the plating temperature identified in Table 1, below. The plating solution pH was adjusted using sulfamic acid.

A copper foil cathode was immersed in 1% H₂SO₄ (aq.) for 30 seconds, then rinsed thoroughly in deionized water. The sample was placed in a plating cell into which the nickel sulfamate and alumina mixture had been placed. The solution was circulated throughout the cell by an external peristaltic pump at a rate of one plating solution volume per minute. Plating electrodes were attached, and the sample plated at a current density of 50 Amperes per Square Foot (ASF) for a period of 10 seconds. In the case of a sample plated at pH 6.0 at 20 degrees C., a resistive layer sheet resistivity of 992 ohms per square was observed.

The sheet resistivity can be altered by manipulating one or more process parameters such as reducing or increasing the solids content of the co-deposit material, or altering the amount of resistive metal deposited. The latter is controlled by proportionally increasing the number of ampere seconds per square foot. The former may be varied by agitation, the use of surface-active substances, and other techniques such as those disclosed in U.S. Pat. No. 4,441,965, the specification of which is incorporate herein by reference. The desired sheet resistance may also be obtained empirically by varying the bath conditions and compositions, measuring the resistance of the layer produced until that resistance is achieved. By varying processing parameters, co-deposit layers with sheet resistivities of from 1.0 ohms per square to 11,700 ohms per square have been produced using solutions in the pH range of 2 to 6, a temperature range of 20 to 50 degree Celsius at a constant 30 grams per liter of alumina and 50 ASF current density. Generally, an increase in plating solution temperature will reduce the sheet resistivity of the resistive layer. This effect is show in Table 1, below.

TABLE 1

| Temperature, deg C. | H | Sheet Resistivity, Ohms per square |
|---|---|---|
| 50 | 5.6 | 3.66 |
| 44 | 5.6 | 5.63 |
| 35 | 5.8 | 177.4 |

In an alternative application method, the non-conductive particles may be placed in close physical proximity to the cathode, for example as a slurry of plating electrolyte, in this example nickel sulfamate, and non-conductive particles, for example alumina. The gap between anode and cathode is then filed with plating electrolyte without disturbing the slurry. The co-deposit layer is then formed by plating the resistive metal layer around the particles contained in the slurry.

In still a further alternative method, a resistive co-deposit layer may be formed by placing the non-conductive particles in close proximity to the cathode in a slurry of electrolyte for plating the cathode metal, such as copper. A plating current is applied to adhere the particles with a dendritic copper deposit. In this example, a copper sulphate solution, of 48 g Cu and 7 g free H₂SO₄ per liter concentration, was used to adhere the particles at 50 Amperes per square foot, for a period of about 60 seconds. The copper foil with adherent particles is then rinsed in deionized water. The resistive layer is subsequently placed onto the adherent particles using a nickel sulfamate plating solution as previously described.

Alternatively, the co-deposit layer may be produced by other means including but not limited to plasma spray, vacuum deposition, electroless deposition and sputtering.

The foil may be subsequently treated on either side with adhesion promoters, oxidation preventors, corrosive barrier layers, or other treatments well known to those skilled in producing copper foils for electric applications.

Application

The resistive elements are produced by a differential etching process. In this process, the conductive traces for interconnection are imaged and etched in a conventional manner. A second image and etching step is performed using an etchant that will remove one conductive layer, but will not substantially affect the underlying resistive layer. In this case, a two layer foil including a conductive metal layer with the shiny side including a co-deposit layer is applied to a partially cured epoxy “pre-preg” and laminated under heat and pressure sufficient to flow and cure the epoxy, forming a laminate.

An etchant resistant material is applied to the outer facing surface in the desired pattern, and the laminate etched in an acidic etchant, in this case aqueous cupric chloride or ferric chloride. The resulting etched laminate is cleaned, rinsed and dried.

A second etchant resistant material is applied, protecting the desired conductive copper layer from etching. The laminate is then placed in an ammoniacal etchant, in this case ammonium persulphate to remove the highly conductive copper from above the co-deposit resistance elements. The remaining etchant resistant material is removed and the panel is subsequently rinsed and dried.

In another method, the resistive elements are formed by machining the necessary elements using mechanical, electrical or chemical machining methods.

Although the invention has been shown and described with respect to certain preferred embodiments, it is obvious that equivalent variations and modifications will occur to those skilled in the art upon reading and understanding the specification. The present invention includes all such equivalent alterations and modifications that fall within the scope of the following claims.

What we claim is:

1. An electrically resistive composite material comprising a conductive material and a non-conductive material.

2. The electrically resistive composite material of claim 1 wherein the non-conductive material is a non-conductive particulate material.

3. The electrically resistive composite material of claim 2 wherein the particulate material is selected from metal oxides, metal nitrides, ceramics, and mixtures thereof.

4. The electrically resistive composite material of claim 3 wherein the non-conductive particulate materials is selected from the group consisting of boron nitride, silicon carbide, alumina, silica, platinum oxide, tantalum nitride, talc, polyethylene tetra-fluoroethylene (PTFE), epoxy powders, and mixtures thereof.

5. The electrically resistive composite material of claim 1 wherein the conductive material is a metal, metalloid, alloy, or combination thereof.

6. A multi-layer foil comprising a conductive metal layer and a layer of the electrically resistive composite material of claim 1.

7. The multi-layer foil of claim 6 wherein the conductive metal layer and the conductive material are not the same material.

8. The multi-layer foil of claim 6 wherein the electrically resistive composite material layer non-conductive material is a non-conductive particulate material selected from metal oxides, metal nitrides, ceramics, and mixtures thereof.

9. The multi-layer foil of claim 8 wherein the non-conductive particulate materials is selected from the group consisting of boron nitride, silicon carbide, alumina, silica, platinum oxide, tantalum nitride, talc, polyethylene tetra-fluoroethylene (PTFE), epoxy powders, and mixtures thereof.

10. The multi-layer foil of claim 6 wherein the conductive material is a metal, metalloid, alloy, or combination thereof.

11. A multi-layer foil comprising a copper metal layer and an electrically resistive composite material layer associated with the copper metal layer shiny surface wherein the electrically resistive composite material layer includes from about 0.01 to about 99.9 area % of a conductive metal other than copper and from about 0.01 to about 99.9 area % of particles of a non-conductive material selected from alumina, boron nitride, and mixtures thereof.

12. A circuit board including an integral resistor comprising;
(a) an insulative substrate layer having first surface and a second surface;
(b) an integral resistor located on the insulative substrate first surface wherein the integral resistor further comprises an electronically resistive composite material including a conductive material and a non-conductive material wherein the integral resistor has a first end and a second end; and
(c) a first conductive metal layer associated with the integral resistor first end and a second conductive metal associated with the integral resistor second end.

13. The multi-layer foil of claim 12 wherein the electrically resistive composite material layer non-conductive material is a non-conductive particulate material selected from metal oxides, metal nitrides, ceramics, and mixtures thereof.

14. The multi-layer foil of claim 13 wherein the non-conductive particulate materials is selected from the group consisting of boron nitride, silicon carbide, alumina, silica, platinum oxide, tantalum nitride, talc, polyethylene tetra-fluoroethylene (PTFE), epoxy powders, and mixtures thereof.

15. The multi-layer foil of claim 12 wherein the conductive material is a metal, metalloid, alloy, or combination thereof.

16. A method for manufacturing a printed circuit board including an integral resistor comprising the steps of:
(a) applying a first photosensitive etch resistant material to a laminate including an insulative substrate, a conductive metal layer having an exposed top surface, and a resistive material layer located between the conductive metal layer and the insulative substrate, wherein the photosensitive etch resistant material is applied to the exposed top surface of the conductive metal layer;
(b) irradiating at least a portion of the photosensitive etch resistant material to give irradiated portions of the photosensitive etch resistant material and non-irradiated portions of the photosensitive etch resistant material;
(c) removing a portion of the photosensitive etch resistant material to expose a portion of the conductive metal layer that does not correspond to the integral resistor;
(d) removing the conductive metal layer and the resistive material layer exposed in step (c) to form a partially formed integral resistor;
(e) removing the portion of the photosensitive etch resistant material from the partially formed integral resistor;
(f) applying a second photosensitive etch resistant material to the partially formed integral resistor;
(g) masking portions of the second photosensitive etch resistant material and irradiating the unmasked portions of the second photosensitive etch resistant material to form an integral resistor; and
(h) removing the photosensitive etch resistant material that covers the integral resistor and removing the conductive metal layer associated with the integral resistor to expose the underlying resistive material layer to form the integral resistor.

17. The method of claim 16 wherein the electrically resistive material is a co-deposit material including a conductive material and a non-conductive material wherein the conductive metal layer and the conductive material are not the same material.

18. The method of claim 17 wherein the non-conductive material is a non-conductive particulate material selected from metal oxides, metal nitrides, ceramics, and mixtures thereof.

19. The method of claim 18 wherein the non-conductive particulate material is selected from the group consisting of boron nitride, silicon carbide, alumina, silica, platinum oxide, tantalum nitride, talc, polyethylene tetra-fluoroethylene (PTFE), epoxy powders, and mixtures thereof.

20. The method of claim 16 wherein the multi-layer foil includes a copper metal layer having a shiny surface and a matte surface and an electrically resistive co-deposit layer associated with the copper metal layer, shiny surface wherein the electrically resistive co-deposit layer includes from about 0.01 to about 99.9 wt % of a conductive material other than copper and from about 0.1 to about 99.9 wt % of particles of a non-conductive material selected from alumina, boron nitride, and mixtures thereof.
